(19) United States
(12) Patent Application Publication
(10) Pub. No.: US 2026/0172296 A1
(43) Pub. Date: Jun. 18, 2026

(54) TARGET SENSING AND TRACKING IN 5G NETWORKS

(71) Applicant: TIAMI NETWORKS INC., Elk Grove, CA (US)

(72) Inventors: Amitav Mukherjee, Elk Grove, CA (US); IAN ELLIS HULEDE, Sacremento, CA (US)

(73) Assignee: TIAMI NETWORKS INC., Elk Grove, CA (US)

(21) Appl. No.: 19/418,885

(22) Filed: Dec. 12, 2025

Related U.S. Application Data
(60) Provisional application No. 63/730,981, filed on Dec. 12, 2024.

(51) Int. Cl. H04L 27/26; G01S 13/58; G01S 13/72; G01S 13/89

(52) U.S. Cl. CPC H04L 27/2607; G01S 13/58; G01S 13/72; G01S 13/89

(57) ABSTRACT

According to an aspect of the present disclosure, a method for target sensing and tracking in a 5G (fifth generation) cellular network is performed in a receiver device in the 5G cellular network. The method comprises receiving a plurality of cellular signals originating from a transmitter device, the plurality of cellular signals including reflected signals received from a set of targets along multiple signal paths having different lengths; reconstructing, based on the plurality of cellular signals, single-sideband signals to form a set of reference signals; extracting from the plurality of cellular signals, a cyclic prefix (CP) containing portions of the reflected signals to form a set of surveillance signals; calculating a cross ambiguity function (CAF) based on the set of reference signals and the set of surveillance signals; and generating based on the CAF, a range-doppler (RD) map for detection of the set of targets.

### PRIORITY CLAIM

The instant patent application is related to and claims priority from the U.S. Provisional Application No. 63/730,981, Filed on: 12 Dec. 2024, entitled, “TARGET SENSING AND TRACKING USING REFLECTED SIGNALS IN THE CYCLIC PREFIX (CP) OF 5G NR SIGNALS”, which is incorporated in its entirety herewith.

### BACKGROUND

### Technical Field

The disclosed embodiment is in the technical field of wireless communications, and more specifically to target sensing and tracking in in 5G (“fifth generation”) cellular networks.

### Description of the Related Art

Wireless communication systems are the basis of transfer of information between one point to another or more without the use of electrical conductor, optical fiber or other medium for the transfer. The most common wireless technologies use radio waves. Examples are Bluetooth [R], mobile, radio receivers, satellite television, broadcast television.

Multipath fading occurs due to reflections, diffraction, and scattering of a transmitted signal by obstacles in the environment. This causes the transmitted signal to follow multiple paths to the receiver device, resulting in time delays and variations in signal amplitude. These effects can distort the received signal and may lead to errors in decoding the transmitted data. The two main effects of multipath fading are Intersymbol Interference (ISI) and Inter-Carrier Interference (ICI).

Intersymbol Interference (ISI) affects the transmission quality of digital signals. ISI occurs when the delayed copies of the transmitted signal overlap with the subsequent symbols, which causes interference between them. This results in the loss of information and errors in decoding the transmitted data.

Inter-Carrier Interference (ICI) affects demodulation on the receiver side when the orthogonality of subcarriers in an Orthogonal Frequency Division Multiplexing (OFDM) system is compromised. ICI occurs when the frequency of the received signal changes due to the doppler effect caused by the movement of the transmitter or receiver. This can cause interference between adjacent sub-carriers in the frequency domain, which result in errors in decoding the transmitted data.

However, the inventors of the present disclosure have identified that such multipath signals received by a receiver device may be used as a basis for target (object) sensing and tracking in 5G cellular networks.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to an aspect of the present disclosure, a method for target sensing and tracking in a 5G (fifth generation) cellular network is performed in a receiver device in the 5G cellular network. The method comprises receiving a plurality of cellular signals originating from a transmitter device, the plurality of cellular signals including reflected signals received from a set of targets along multiple signal paths having different lengths; reconstructing, based on the plurality of cellular signals, single-sideband signals to form a set of reference signals; extracting from the plurality of cellular signals, a cyclic prefix (CP) containing portions of the reflected signals to form a set of surveillance signals; calculating a cross ambiguity function (CAF) based on the set of reference signals and the set of surveillance signals; and generating based on the CAF, a range-doppler (RD) map for detection of the set of targets.

According to another aspect of the present disclosure, the 5G cellular network is 5G NR (New Radio), wherein the plurality of cellular signals is according to Orthogonal Frequency Division Multiplexing (OFDM), wherein the CP is a guard interval provided between consecutive OFDM symbols, and is a copy of the last part of each OFDM symbol.

According to one more aspect of the present disclosure, a duration of the CP is set longer than the difference between the fastest and slowest signal paths in the multiple signal paths to ensure that all of the reflected signals for a OFDM symbol are received within the duration of the CP of the next OFDM symbol.

According to a further aspect of the present disclosure, the reconstructing comprises i) synchronization signal block (SSB) position detection, ii) physical broadcast channel (PBCH) decoding, iii) SSB synthesis and OFDM modulation, and iv) SS/PBCH block signal reconstruction from the frequency domain into the time domain.

According to yet another aspect of the present disclosure, the receiver device is part of systems for vehicle sensing, gesture recognition, smart cities, unmanned aerial vehicle (UAV) flight path tracking, and performing integrated sensing and communication (ISAC).

According to another aspect of the present disclosure, the receiver device is a user equipment (UE) and the transmitter device is a base station in the 5G cellular network.

Thus, aspects of the present disclosure are directed to a wireless communication system that involves a method for sensing and tracking of objects/targets employing reflected signals in the cyclic prefix (CP) of 5G NR signals.

Several aspects of the disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### BRIEF DESCRIPTION OF THE DRAWINGS

Example embodiments of the disclosure will be described with reference to the accompanying drawings briefly described below.

FIG. 1 is a block diagram illustrating an example environment (computing system) in which several aspects of the present disclosure can be implemented.

FIG. 2 illustrates a cyclic prefix in 5G cellular signals, according to the aspects of the disclosed embodiment.

FIG. 3 is a flow chart illustrating the manner in which target sensing and tracking in a 5G cellular network is facilitated according to the aspects of the disclosed embodiment.

FIG. 4 illustrates the overlap of multipath signals within a cyclic prefix, according to the aspects of the disclosed embodiment.

FIG. 5 illustrates an example hardware architecture configured to implement the signal-processing operations described in the present disclosure for target sensing and tracking using reflected 5G NR signals, according to the aspects of the disclosed embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

All documents cited in the present specification are hereby incorporated by reference in their totality. In particular, the teachings of all documents herein specifically referred to are incorporated by reference.

Example embodiments of the present disclosure are described with reference to the accompanying figures.

### 1. Definitions

“Transmitter” refers to an electronic device which transmits data (via an antenna) to receiver(s). The device converts physical data into corresponding electrical signals.

“Receiver” refers to an electronic device for receiving (via an antenna) the transmitted electrical signals and convert them to physical data (to identify message(s) from the transmitter).

“Reflected signals” refers to copies of the original transmitted signal that have bounced off various objects such as buildings, mountains, or other surfaces before reaching the receiver.

“Multipath reflection” or “Multipath propagation” refers to a phenomenon that occurs when radio signals reach a receiving antenna via multiple paths, which can cause signal interference and fading.

“Orthogonal Frequency Division Multiplexing (OFDM)” refers to modulation technique which divides a high-data-rate modulating signal into multiple lower data-rate sub-signals, which are then transmitted simultaneously over several orthogonal subcarriers.

“Cyclic Prefix (CP)” refers to a guard interval which is added between OFDM symbols to reduce Intersymbol Interference (ISI).

“Intersymbol Interference (ISI)” refers to a phenomenon encountered in communication systems where the energy of one transmitted symbol spills over into subsequent symbols, which causes interference.

“Fast Fourier Transform (FFT)” refers to a mathematical algorithm used in 5G networks to convert time-domain signals into frequency-domain signals.

“Fast Fourier Transform (FFT) Window” refers to the duration over which the FFT is computed on the received signal to demodulate it back into its constituent subcarriers.

“Synchronization Signal Block (SSB)” refers to signals that are transmitted periodically by a Base Station used by a receiver to connect to the network.

“Doppler” refers to a change in frequency due to the doppler effect.

“Surveillance channel” refer to a channel that is used to listen to echoes from reflected targets and can be used for real-time surveillance and target tracking.

“Integrated Sensing and Communications (ISAC)” refers to a technology that combines sensing and communication system to detect objects and communication data simultaneously.

### 2. Example Environment

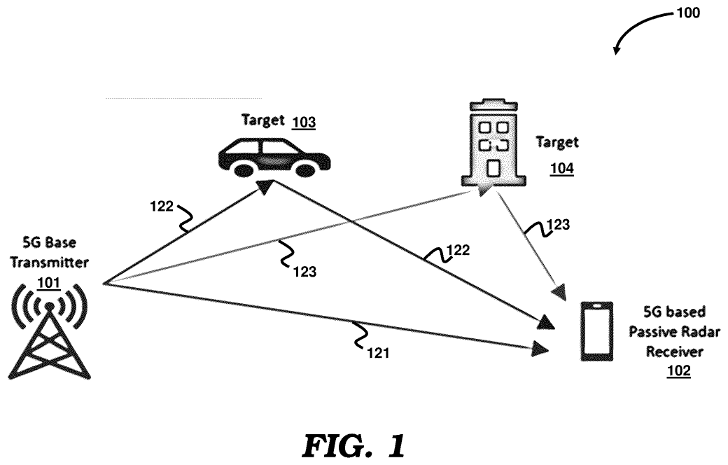

FIG. 1 is a block diagram illustrating an example environment (computing system) in which several aspects of the present disclosure can be implemented. 100 illustrates a wireless communication system (5G network) for target sensing and tracking.

Transmitter device 101 is an electronic device that transmits data (via an antenna) to receiver device(s) such as receiver device 102. In one embodiment, receiver device 102 is a user equipment (UE) and transmitter device 101 is a base station in a 5G cellular network. Targets 103 and 104 are objects such as vehicles, buildings, mountains, or other surfaces, from which the cellular signals have bounced/reflected back as shown in the Figure.

Paths 121, 122 and 123 show the different paths that reflected signals took before being received by receiver device 102. The multipath reflection occurs when signals transmitted from an OFDM transmitter (101) reflect off various objects or surfaces (targets 103 and 104) before arriving at the receiver end (102). These reflections create multiple signal paths which have different lengths, causing distortion from transmitting signal to receiver end and the copies of the transmitted signal to reach the receiver at different times. As noted above, this phenomenon can lead to inter-symbol interference (ISI), where delayed copies of a signal interfere with subsequent symbols.

Cyclic prefix (CP) is a technique in 5G New Radio (NR) to counter the effect of multipath propagation. The cyclic prefix helps in mitigation of multipath reflections by providing a buffer period between symbols, as is well known. The cyclic prefix serves as a guard interval added to the beginning of each transmitted symbol, which is a copy of the last part of the transmitted symbol and is also known as cyclic prefix for its cyclic repetition. The cyclic prefix helps in reduction of inter-symbol interference (ISI) and inter-carrier interference (ICI) caused by multipath fading.

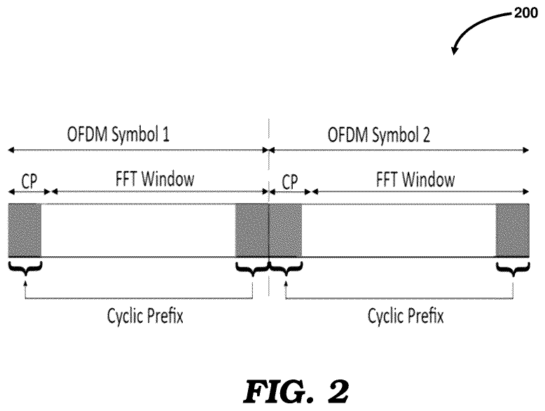

FIG. 2 illustrates a cyclic prefix in 5G cellular signals, according to the aspects of the disclosed embodiment. Specifically, 200 illustrates the cyclic prefix implemented with orthogonal frequency division multiplexing (OFDM) system technique for mitigation of ISI and ICI, due to multipath propagation.

It may be observed that the inserted cyclic prefix serves as a guard interval between consecutive OFDM symbols, which effectively mitigates ISI stemming from preceding symbols and orthogonality of subcarrier. Cyclic prefix acts as a protective mechanism to ensure the integrity of the data across the transmission channel. FFT window captures the main body of the OFDM symbol at the receiver device.

Aspects of the present disclosure are directed to target sensing and tracking using reflected signals in the cyclic prefix (CP) of 5G NR signals. The cyclic prefix implemented in OFDM system, a feature in 5G to mitigate ISI due to multipath propagation, also extract the echoes from reflected paths in a multipath propagation environment. The reflected paths/signals may be used by receiver device 102 to perform target sensing and tracking as described in detail below.

### 3. General Flow

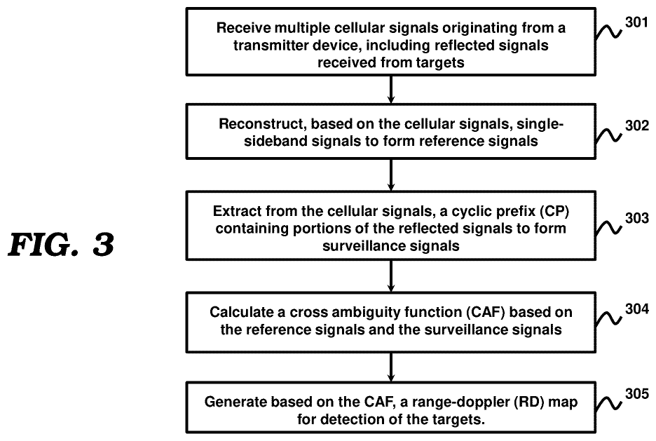

FIG. 3 is a flow chart illustrating the manner in which target sensing and tracking in a 5G cellular network is facilitated according to the aspects of the disclosed embodiment. The flowchart is described with respect to FIG. 1, in particular receiver device 102 merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.

In step 301, receiver device 102 receives multiple cellular signals (via paths 121, 122, 123) originating from a transmitter device (101), including reflected signals (via paths 122, 123) received from targets (103, 104) along multiple signal paths (122, 123) having different lengths.

In step 302, receiver device 102 reconstructs, based on the received cellular signals, single-sideband signals to form reference signals. According to an aspect, such reconstructing entails i) synchronization signal block (SSB) position detection, ii) physical broadcast channel (PBCH) decoding, iii) SSB synthesis and OFDM modulation, and iv) SS/PBCH block signal reconstruction from the frequency domain into the time domain.

In step 303, receiver device 102 extracts from the received cellular signals, a cyclic prefix (CP) containing portions of the reflected signals to form surveillance signals. According to an aspect, the 5G cellular network is 5G NR (New Radio), with the received cellular signals being according to Orthogonal Frequency Division Multiplexing (OFDM). As such, the CP is a guard interval provided between consecutive OFDM symbols, and is a copy of the last part of each OFDM symbol.

According to another aspect, a duration of the CP is set longer than the difference between the fastest and slowest signal paths in the multiple signal paths (121, 122, 123) to ensure that all of the reflected signals for a OFDM symbol are received within the duration of the CP of the next OFDM symbol.

In step 304, receiver device 102 calculates a cross ambiguity function (CAF) based on the reference signals and the surveillance signals. The specific calculation performed is described in below sections.

In step 305, receiver device 102 generate based on the CAF, a range-doppler (RD) map for detection of the targets. The generation of the RD map based on the CAF may be performed in a known way.

Thus, aspects of the present disclosure facilitate target sensing and tracking in a 5G cellular network. According to an aspect, receiver device 102 may be implemented as part of systems for vehicle sensing, gesture recognition, smart cities, unmanned aerial vehicle (UAV) flight path tracking, and performing integrated sensing and communication (ISAC).

The manner in which several aspects of the present disclosure are provided according to the operation of FIG. 3 is described in detail below.

### 4. Sample Implementation

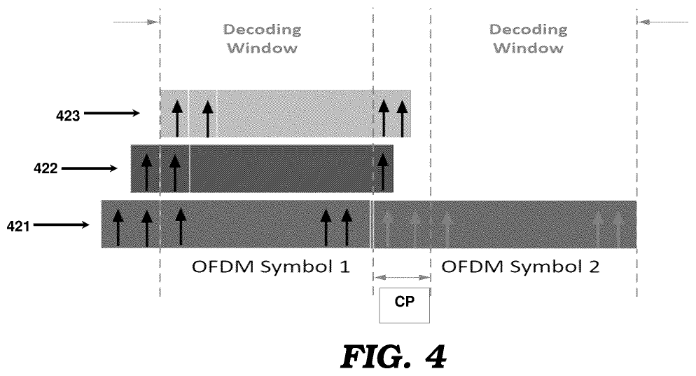

FIG. 4 illustrates the overlap of multipath signals within a cyclic prefix, according to the aspect of the disclosed embodiment. Specifically, 421, 422, and 423 indicate cellular (multipath) signals received via paths 121, 122, and 123 respectively. It may be observed that portions (indicated by black up arrows) of the multipath signals (422 and 423) of the previous symbol (symbol 1) have overlapped/entered into the next symbol (symbol 2) but lies within the CP part of the next symbol.

The length of the cyclic prefix is chosen based on the maximum expected delay spread of the channel, which is the difference in arrival times between the fastest and slowest signal paths. The CP duration is set to be longer than this maximum delay spread to ensure that all multipath reflections of a given symbol arrive within the duration of the CP. The multipath signals which reflect off the targets arrive at a later time and their signals lie within CP of the next symbol.

Before demodulation at the receiver end, the CP is removed from each OFDM symbol and the signals are extracted from the reflected signal. These signals represent system reflections from echoes in a passive radar and serve as a surveillance channel. Surveillance channel support applications which require a high quality of service (QoS) to real time surveillance and tracking of the targets. To these extracted signals post-processing algorithm will be applied for sensing and detecting the targets. These enables the performance of the 5G devices to perform integrated sensing and communications (ISAC) in the surrounding environment.

The algorithm to perform target sensing and tracking is in two major phases: Phase I-Single-sideband (SSB) Signal Reconstruction and Phase II-Cyclic Prefix Extraction.

### A) Steps of Phase I—SSB Signal Reconstruction.

i) SSB position detection
ii) PBCH decoding
iii) SSB synthesis and OFDM modulation
iv) SS/PBCH block signal reconstruction from the frequency domain into the time domain. This step result in a reference signal.

### B) Steps of Phase II—Cyclic Prefix Extraction.

i) Extract the cyclic prefix at the receiver end, to obtain the reflected pulses in the signal. These signals are used as the surveillance signal.
ii) To determine the range-doppler (RD) map on which a target may be detected. This will be achieved by calculating the Cross Ambiguity Function (CAF) as defined in the below equation:

$$Ψ [ m , k ] = {\sum }_{n = 0}^{N - 1} {x}_{sur} [ n ] {x}_{ref}^{*} [ n - m ] \cdot exp ( - j \frac{2 π}{N} kn )$$

Where,
   xₛᵤᵣ—surveillance signal
   x_{ref}—reference signal
   N—number of reference and surveillance signal sample
   k—frequency bins
   m—signal delay samples

The calculated CAF is thereafter used to generate the RD map in a known way, as will be apparent to one skilled in the relevant arts.

Thus, the system uses n the cyclic prefix (CP) implemented in Orthogonal Frequency Division Multiplexing (OFDM) system, a feature in 5G to mitigate inter-symbol interference due to multipath propagation, to extract the echoes from reflected paths in a multipath propagation environment, and to perform target/object sensing and tracking.

### 5. Uses, Applications and Benefits of the Disclosure

Some of the advantages of the instant disclosure are noted below:

Vehicular Sensing: Embodiments of the instant disclosure are in development of vehicular sensing for autonomous vehicles and smart transportation solutions, offering enhanced driver assistance, traffic management, and road safety.

Gesture Recognition: The instant disclosure can be used in the interpretation of human gestures, such as hand movements or body postures, as input commands for electronic devices or computer interfaces, revolutionizing the way that humans interact with technology which will help in applications in gaming, virtual reality, human-computer interaction, and healthcare, enhancing user experiences and enabling more intuitive control of digital devices.

Smart Cities: Smart cities leverage advanced technologies, including IoT sensors, data analytics, and connectivity, to enhance urban living by optimizing infrastructure, energy usage, transportation, and public services. With the instant disclosure, smart cities will be much easier to implement due to the wide usage of more 5G devices.

UAV flight path tracking: This involves real-time monitoring and control of the trajectory and position of drones using GPS, sensors, and communication systems. With the instant disclosure in the wireless communications systems, UAV tracking will be made possible thereby making the instant disclosure practical for general applications.

Best mode to practice the present disclosure is the usage of the instant disclosure in integrated sensing and communication (ISAC) in the sixth generation (6G) of wireless communications to utilize wireless resources efficiently, realize wide area environment sensing, and even to pursue mutual benefits. The present technology in active radar technology analyses the time delay between the transmitted pulse and the received echo (time-of-flight), along with the Doppler shift (frequency change) of the returning signal to determine the target's position and velocity.

It should be appreciated that the above noted features can be implemented in various embodiments as a desired combination of one or more of hardware, execution modules and firmware. The description is continued with respect to one embodiment in which various features are operative when execution modules are executed.

### 6. Hardware

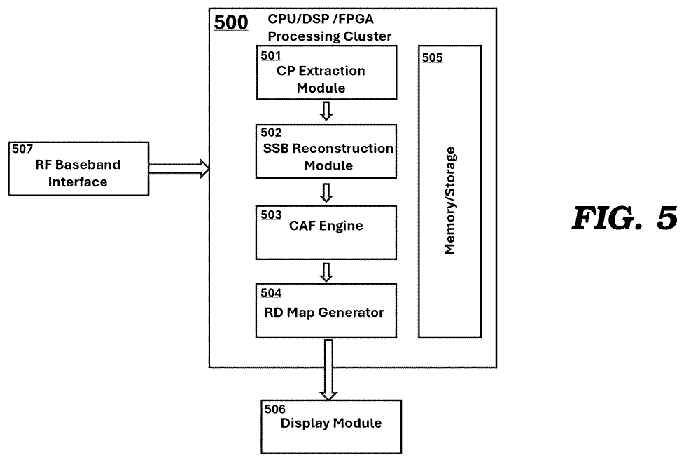

FIG. 5 illustrates an example hardware architecture (500) configured to implement the signal-processing operations described in the present disclosure for target sensing and tracking using reflected 5G NR signals, according to the aspects of the disclosed embodiment. In various embodiments, hardware system 500 may be integrated within a receiver device, a dedicated passive-sensing platform, or a distributed edge-compute module operating alongside a 5G radio front end.

The system includes an RF/Baseband Interface 507, which receives digitized in-phase and quadrature (I/Q) samples corresponding to downlink 5G NR signals transmitted by a base station and reflected by surrounding targets. Interface 507 transfers these baseband samples directly into the processing cluster 500 for real-time analysis.

Processing cluster (CPU/DSP/FPGA Processing Cluster) 500 comprises a programmable computation subsystem 500 responsible for executing the two-phase sensing pipeline disclosed herein. Within subsystem 500, a set of specialized execution modules perform operations on the incoming 5G signals as described in detail below.

CP Extraction Module 501 is configured to isolate the cyclic-prefix regions that contain multipath reflections. This module outputs surveillance signals containing the reflected energy used for sensing and ranging.

SSB Reconstruction Module 502 reconstructs reference signals by performing synchronization signal block (SSB) detection, PBCH decoding, SSB synthesis, and OFDM modulation. The module generates clean, time-domain reference signals corresponding to the transmitted waveform.

CAF Engine 503 computes the cross-ambiguity function (CAF) between the surveillance signals generated by CP Extraction Module 501 and the reference signals produced by SSB Reconstruction Module 502. The CAF quantifies time-delay and Doppler-shift relationships needed for target detection.

RD Map Generator 504 processes CAF outputs to generate a range-Doppler (RD) map representing energy intensity over delay and Doppler bins. Peaks in the RD map correspond to potential target detections.

Memory/Storage 505 provides persistent and non-persistent storage for executable firmware, calibration parameters, FFT configurations, CAF integration windows, and RD map thresholds. During real-time operation, memory 505 also buffers high-rate baseband data and intermediate processing results from modules 501-504.

The system optionally includes a Display Module 506 for rendering RD maps, detections, and tracking outputs. In embedded or headless deployments, outputs from module 504 may instead be transmitted over a network interface to external systems without requiring local visualization.

The components of FIG. 5 communicate over internal buses and data pathways optimized for high-throughput signal movement. When executing the instructions stored within memory/storage 505, the processing cluster 500 performs: (i) extraction of reflected signals from cyclic-prefix regions; (ii) reconstruction of network reference signals; (iii) computation of a cross-ambiguity function; and (iv) generation of range-Doppler maps for target detection and tracking.

Thus, hardware system 500 provides a dedicated architecture optimized for 5G-based passive sensing and supports real-time ISAC (Integrated Sensing and Communication) functionality across a variety of applications including vehicle detection, UAV tracking, gesture sensing, and smart-city infrastructure monitoring.

Some or all of the data and instructions noted above may be provided on a removable storage unit, and the data and instructions may be read and provided by a removable storage drive to processing cluster 500. Floppy drive, magnetic tape drive, CD-ROM drive, DVD

Drive, Flash memory, removable memory chip (PCMCIA Card, EPROM) are examples of such removable storage drive.

Removable storage unit may be implemented using storage format compatible with removable storage drive such that removable storage drive can read the data and instructions. Thus, removable storage unit includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to hardware system 500. Processing cluster 500 may retrieve the software instructions (forming the execution modules) and execute the instructions to provide various features of the present invention described above.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the invention have been shown and described in detail to illustrate the inventive principles, it will be understood that the invention may be embodied otherwise without departing from such principles.

The figures and/or screen shots shown highlighting the functionality and advantages of the present invention are presented for example purposes only. The present invention is sufficiently flexible and configurable, such that it may be utilized in ways other than that shown in the figures.

The examples and embodiments described herein are for illustrative purposes only and that various modifications or changes in light thereof will be suggested to persons skilled in the art and are to be included within the spirit and purview of this application and scope of the appended claims.

What is claimed is:

1. A method for target sensing and tracking in a 5G (fifth generation) cellular network, the method being performed in a receiver device in the 5G cellular network, the method comprising:
receiving a plurality of cellular signals originating from a transmitter device, the plurality of cellular signals including reflected signals received from a set of targets along multiple signal paths having different lengths;
reconstructing, based on the plurality of cellular signals, single-sideband signals to form a set of reference signals;
extracting from the plurality of cellular signals, a cyclic prefix (CP) containing portions of the reflected signals to form a set of surveillance signals;
calculating a cross ambiguity function (CAF) based on the set of reference signals and the set of surveillance signals; and
generating based on the CAF, a range-doppler (RD) map for detection of the set of targets.

2. The method of claim 1, wherein the 5G cellular network is 5G NR (New Radio), wherein the plurality of cellular signals is according to Orthogonal Frequency Division Multiplexing (OFDM), wherein the CP is a guard interval provided between consecutive OFDM symbols, and is a copy of the last part of each OFDM symbol.

3. The method of claim 2, wherein a duration of the CP is set longer than the difference between the fastest and slowest signal paths in the multiple signal paths to ensure that all of the reflected signals for a OFDM symbol are received within the duration of the CP of the next OFDM symbol.

4. The method of claim 1, wherein the reconstructing comprises i) synchronization signal block (SSB) position detection, ii) physical broadcast channel (PBCH) decoding, iii) SSB synthesis and OFDM modulation, and iv) SS/PBCH block signal reconstruction from the frequency domain into the time domain.

5. The method of claim 1, wherein the receiver device is part of systems for vehicle sensing, gesture recognition, smart cities, unmanned aerial vehicle (UAV) flight path tracking, and performing integrated sensing and communication (ISAC).

6. The method of claim 1, wherein the receiver device is a user equipment (UE) and the transmitter device is a base station in the 5G cellular network.

7. A receiver device in a 5G (fifth generation) cellular network for target sensing and tracking in the 5G cellular network, the receiver device configured to perform the actions of:
receiving a plurality of cellular signals originating from a transmitter device, the plurality of cellular signals including reflected signals received from a set of targets along multiple signal paths having different lengths;
reconstructing, based on the plurality of cellular signals, single-sideband signals to form a set of reference signals;
extracting from the plurality of cellular signals, a cyclic prefix (CP) containing portions of the reflected signals to form a set of surveillance signals;
calculating a cross ambiguity function (CAF) based on the set of reference signals and the set of surveillance signals; and
generating based on the CAF, a range-doppler (RD) map for detection of the set of targets.

8. The receiver device of claim 7, wherein the 5G cellular network is 5G NR (New Radio), wherein the plurality of cellular signals is according to Orthogonal Frequency Division Multiplexing (OFDM), wherein the CP is a guard interval provided between consecutive OFDM symbols, and is a copy of the last part of each OFDM symbol.

9. The receiver device of claim 8, wherein a duration of the CP is set longer than the difference between the fastest and slowest signal paths in the multiple signal paths to ensure that all of the reflected signals for a OFDM symbol are received within the duration of the CP of the next OFDM symbol.

10. The receiver device of claim 7, wherein the reconstructing comprises i) synchronization signal block (SSB) position detection, ii) physical broadcast channel (PBCH) decoding, iii) SSB synthesis and OFDM modulation, and iv) SS/PBCH block signal reconstruction from the frequency domain into the time domain.

11. The receiver device of claim 7, wherein the receiver device is part of systems for vehicle sensing, gesture recognition, smart cities, unmanned aerial vehicle (UAV) flight path tracking, and performing integrated sensing and communication (ISAC).

12. The receiver device of claim 7, wherein the receiver device is a user equipment (UE) and the transmitter device is a base station in the 5G cellular network.

13. A non-transitory machine-readable medium storing one or more sequences of instructions for target sensing and tracking in a 5G (fifth generation) cellular network, wherein execution of said one or more instructions by one or more processors contained in a receiver device in the 5G cellular network causes the receiver device to perform the actions of:
receiving a plurality of cellular signals originating from a transmitter device, the plurality of cellular signals including reflected signals received from a set of targets along multiple signal paths having different lengths;
reconstructing, based on the plurality of cellular signals, single-sideband signals to form a set of reference signals;
extracting from the plurality of cellular signals, a cyclic prefix (CP) containing portions of the reflected signals to form a set of surveillance signals;
calculating a cross ambiguity function (CAF) based on the set of reference signals and the set of surveillance signals; and
generating based on the CAF, a range-doppler (RD) map for detection of the set of targets.

14. The non-transitory machine-readable medium of claim 13, wherein the 5G cellular network is 5G NR (New Radio), wherein the plurality of cellular signals is according to Orthogonal Frequency Division Multiplexing (OFDM), wherein the CP is a guard interval provided between consecutive OFDM symbols, and is a copy of the last part of each OFDM symbol.

15. The non-transitory machine-readable medium of claim 14, wherein a duration of the CP is set longer than the difference between the fastest and slowest signal paths in the multiple signal paths to ensure that all of the reflected signals for a OFDM symbol are received within the duration of the CP of the next OFDM symbol.

16. The non-transitory machine-readable medium of claim 13, wherein the reconstructing comprises i) synchronization signal block (SSB) position detection, ii) physical broadcast channel (PBCH) decoding, iii) SSB synthesis and OFDM modulation, and iv) SS/PBCH block signal reconstruction from the frequency domain into the time domain.

17. The non-transitory machine-readable medium of claim 13, wherein the receiver device is part of systems for vehicle sensing, gesture recognition, smart cities, unmanned aerial vehicle (UAV) flight path tracking, and performing integrated sensing and communication (ISAC).

18. The non-transitory machine-readable medium of claim 13, wherein the receiver device is a user equipment (UE) and the transmitter device is a base station in the 5G cellular network.
